(19) United States
(12) Patent Application Publication
(10) Pub. No.: US 2011/0188830 A1
(43) Pub. Date: Aug. 4, 2011

(54) LIGHT CONDUCTIVE PLATE AND MANUFACTURING METHOD THEREOF

(75) Inventors: Masahiro ISAGO, Kitasaku-gun (JP); Takumi SAITO, Kitasaku-gun (JP); Hiroshi CHOU, Kitasaku-gun (JP)

(73) Assignee: MINEBEA CO., LTD., KITASAKU-GUN (JP)

(21) Appl. No.: 13/011,420

(22) Filed: Jan. 21, 2011

(30) Foreign Application Priority Data
Feb. 1, 2010 (JP) 2010-020636

(51) Int. Cl. G02B 6/10; G02B 5/02

(52) U.S. Cl. 385/146; 264/1.1

(57) ABSTRACT

There is provided a high luminous light conductive plate where concave dots formed on the surface of a resin sheet deflect light introduced from a light source to the interior of the light conductive plate so as to diffuse light into an extensive range with a roughened wall surface of the concave dots. An annular projection that flanges the peripheral end portion of each concave dot substantially increases the depth of the concave dots expanding an area contributing to the deflection of the concave dot. The concave dot formed on the surface of the resin sheet is formed by pressing a plurality of concave projections of a press die on the surface of the resin sheet through a cold process.

### BACKGROUND OF THE INVENTION

1. Field of the Invention

The present invention relates to a light conductive plate and a manufacturing method thereof that apply for illumination of the display portion, the operation portion, etc. of an electronic device, and the like.

2. Description of the Related Art

In the past a backlight illumination has been applied for the display portion or the operation portion of electronic devices, and in recent years it has become more general to apply the same backlight illumination to portable electronic devices such as a notebook type personal computer, a cellular phone, and the like. For the backlight illumination, a spread illumination apparatus has been widely applied, the spread illumination apparatus including a light conductive plate where light is introduced from a light source and emits from the surface of the light conductive plate so as to diffuse the light in a wide range.

Considering FIG. 4, one example of conventional spread illumination apparatuses is depicted in an exploded perspective view. In the spread illumination apparatus, a point-like light source 1 is arranged at a place adjacent to the one-side end face (incident surface) 4 of a light conductive plate 2. The spread illumination apparatus is structured as that light emitted from the point-like light source 1 is adapted to exit out from an exit surface 3 of the light conductive plate 2 so as to be guided toward an illuminated body 8 side. The point-like light source 1 is structured, for example, as that an LED chip is covered with a case which has an exit window. Exit light is thus adapted to effectively exit out from the exit window in one direction. The point-like light source (LED) 1 is arranged as that the front side thereof faces to the one-side end face 4 of the light conductive plate 2. The light conductive plate 2 is made of highly transparent materials such as acrylic, polycarbonate, polyester, poly methyl methacrylate, etc. A back surface 5 of the light conductive plate 2, that is, a surface opposed to the exit surface 3, is provided with a later-explained light reflection pattern being able to uniformly exit light that has been introduced from the LED 1 to the interior of the light conductive plate 2 at the entire area of the exit surface 3. Further, a reflecting plate 6 is provided on the back surface 5 side of the light conductive plate 2 so as to cover the back surface 5. The reflecting plate 6 is composed of reflex materials such as white resin, silver-plated plate, etc. whereby light that has been emitted from the back surface 5 of the light conductive plate 2 to outside is reflected so as to be re-introduced into the light conductive plate 2. On the other hand, on the main surface side of the light conductive plate 2, that is, the exit surface side 3 side, an optical filter 7 such as a light diffusion sheet, a luminance enhancement film, etc. is laminated. Here, a member indicated with a reference number 9 in FIG. is a reflecting sheet provided with a light diffusion portion 9a.

In the example as shown in FIG. 4, as the illuminated body 8, a liquid crystal display device provided with a display area 8a and a non-display area 8b is arranged; however, for example, in case that the spread illumination apparatus is structured for a keyboard, a keyboard switch will be arranged as the illuminated body 8. Further, the laminated structure of the front and the rear surfaces of the light conductive plate 2, or the ambient structure of the point-like light source 1 is optionally modifiable.

The light reflection pattern of the light conductive plate 2 is full of shape devisal for improving optical properties. For example, a plurality of grooves are formed on the surface of the light conductive plate in order to uniformly illuminate the entire surface of the light conductive plate by using light that has been introduced from the end surface of the light conductive plate. The section of the groove is formed into a V-shape, and on an inclined surface that is a side opposite to the end surface of the V-shaped groove, smaller grooves in a V-shaped section or an arc-shaped section are formed so as to exit out the light from the luminous surface of the light conductive plate by converting the traveling direction of the light that has been introduced from the end surface of the light conductive plate. See, for example, Patent Application Laid-open No. 2008-226701 in this regard.

As discussed hereinabove, the light conductive plate 2 is fabricated with various materials in high transparency. In case that a transparent acrylic resin is, for example, applied, its manufacturing method may be injection molding. Or, as shown in FIGS. 5A and 5B, the following method may be applied. That is, a resin sheet 12 is heated with a die 14, and predetermined convex forms 14a on the die 14 are heat-transferred on the resin sheet 12 so as to form concave forms 16. Here, FIG. 5A shows only an upper die for convenience sake; however, a lower die should be properly provided. In any cases, the conventional manufacturing methods are as that resin materials are melted, and the cavity formation of the die is accurately transferred on the light conductive plate. Accordingly, the formation of the light conductive plate tends to be undifferentiated due to the cavity formation of the die making the diffusing direction of light undifferentiated. The improvement of light diffusion has been thus demanded. Further, not only does the cost of equipment to apply heat and cooling to the die increases but also the die can not be released until molten resin is hardened to a certain extent making a cycle time per one mold difficult to shorten.

### SUMMARY OF THE INVENTION

The present invention has been made in light of the above problems, and it is an object of the present invention to provide a light conductive plate having superior optical characteristics and stable qualities. Further, the object is also to provide the optically superior light conductive plate as low cost as possible.

Embodiments according to the present invention hereinbelow exemplify some structures of the present invention, and are itemized for facilitating understanding of various structures of the present invention, Each item does not intend to limit the technical scope of the present invention. While considering the best modes to carry out the present invention, even if components of each item is partially substituted or deleted, or even if another component is added thereto, these should be regarded as the elements of the technical scope of the present invention.

In order to achieve the object described above, according to a first aspect of the present invention, there is provided a light conductive plate comprising: a resin sheet; and a plurality of concave dots provided on a surface of the resin sheet, wherein a wall surface of each concave dot is roughened.

In the light conductive plate with this configuration, due to the concave dots formed on the surface of the resin sheet, light that has been introduced from a light source to the interior of the light conductive plate is adapted to be deflected. Here, the light is diffused into a extensive range by means of the roughened wall surface of the concave dots.

In the first aspect of the present invention, the circumferential end portion of each concave dot has a flanged annular projection.

In the light conductive plate with this configuration, the annular projection that is flanged at the circumferential end portion of each concave dot substantially increases the depth of each concave dot so as to expand an area contributing to the deflection of light resulting in luminous improvement.

In the first aspect of the present invention, each concave dot is formed through a cold press by means of a press die on which a plurality of convex projections are formed.

In the light conductive plate with this configuration, due to press stress by which the plurality of convex projections formed on the press die are pressed on the surface of the resin sheet through a cold process, material flow with no melting in the resin sheet is caused so as to form the concave dots on the surface of the resin sheet. Here, on the wall surface of the concave dots, fine and irregular convexoconcave formations are formed by which the convex projections of the press die are pressed, even if the surface of each convex projection of the press die has a smooth surface (the convexoconcave formations will be hereinafter referred to as “press-mark” or “stress-mark”). Accordingly, the wall surface of each concave dot is made roughened. This stress-mark will organize constituent of the product of the light conductive plate finished with the roughened wall surface of the concave dots.

Further, due to press stress by which the plurality of convex projections formed on the press die are pressed on the surface of the resin sheet through a cold process, material flow with no melting in the resin sheet is caused so as to form the annular projections flanged at the circumferential end portion of each concave dot. This annular projection will organize constituent of the product of the light conductive plate. The height of the annular projection is modifiable according to the penetrated amount of the convex projection relative to the resin sheet. The press die by itself thus does not need to have mold for forming the annular projection.

In a second aspect of the present invention, there is provided a light conductive plate comprising: a resin sheet; a plurality of concave dots provided on a surface of the resin sheet; wherein the plurality of concave dots are formed through a cold press by means of a press die on which a plurality of convex projections are formed.

In the light conductive plate with this configuration, the plurality of concave dots are formed on the surface of the resin sheet due to a press stress by which the plurality of convex projections formed on the press die are pressed on the surface of the resin sheet through a cold process, causing material flow with no melting in the resin sheet. Accordingly, by means of the concave dots formed on the surface of the resin sheet, light that is introduced from a light source to the interior of the light conductive plate becomes deflectable.

In a third aspect of the present invention, there is provided a manufacturing method of a light conductive plate in which to form a plurality of concave dots on a surface of a resin sheet through a cold press by means of a press die on which a plurality of convex projections are formed.

In the manufacturing method of the light conductive plate, by pressing the plurality of convex projections of the press die on the surface of the resin sheet through a cold process, material flow with no melting in the resin sheet is caused so as to form the concave dots on the surface of the resin sheet. Here, the stress-mark is formed on the wall surface of each concave dot by which the convex projection of the press die is pressed so as to roughen the wall surface of each concave dot. This stress-mark will organize constituent of the product of the light conductive plate finished with the roughened wall surface of the concave dots.

In the third aspect of the present invention, there is provided a manufacturing method of the light conductive plate wherein a peripheral end portion of each concave dot has a flanged annular projection.

In the manufacturing method of the light conductive plate, due to press stress by which the plurality of convex projections formed on the press die are pressed on the surface of the resin sheet through a cold process, material flow with no melting in the resin sheet is caused so as to form the annular projections flanged at the circumferential end portion of each concave dot. This annular projection will organize the constituent of the product of the light conductive plate. The height of the annular projection is modifiable according to the penetrated amount of the convex projection relative to the resin sheet. The press die by itself thus does not need to have mold for forming the annular projection.

Since the present invention is constituted as discussed hereinabove, it would be possible to provide a light conductive plate with high luminance. Further, it would be also possible to provide the high-luminous light conductive plate with further low cost.

### BRIEF DESCRIPTION OF THE DRAWINGS

FIGS. 1A and 1B are explanatory drawings that depict a light conductive plate and its manufacturing method according to the embodiments of the present invention where FIG. 1A is a sectional drawing at the time of manufacture, and FIG. 1B is a sectional drawing and a partially expanded drawing of the finished product of the light conductive plate;

FIGS. 2A, 2B, 2C and 2D are schematic drawings that exemplify the convex projection of a die in which to be applied to the manufacture of the light conductive plate according to the embodiments of the present invention;

FIGS. 3A and 3B are photos taken with a microscope that expands a concave dot of the light conductive plate according to the embodiments of the present invention;

FIG. 4 is an exploded perspective view that depicts one example of conventional spread illuminating apparatuses; and

FIGS. 5A and 5B are explanatory drawings that depict a conventional light conductive plate and its manufacturing method where FIG. 5A is a sectional drawing at the time of manufacture, and FIG. 5B is a sectional drawing and a partially expanded drawing of the finished product of the light conductive plate.

### DETAILED DESCRIPTION OF THE PREFERRED EMBODIMENTS

Preferred embodiments of the present invention will be described with reference to the accompanying drawings. Here, portions that are identical with or correspondent to conventional art will be indicated with the same references without providing detail explanations thereof.

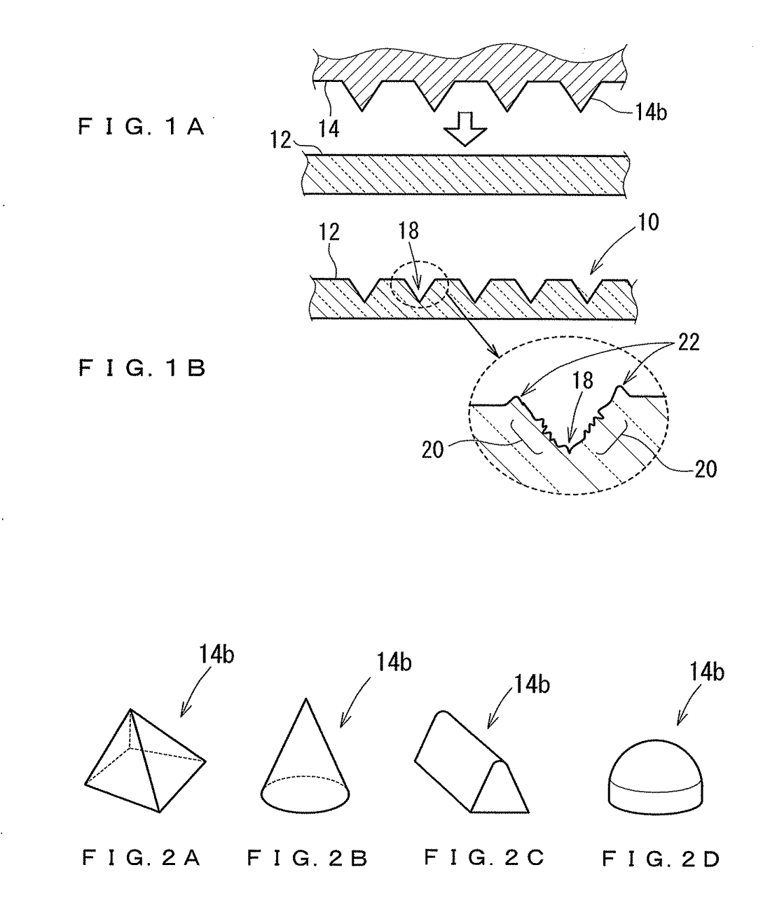

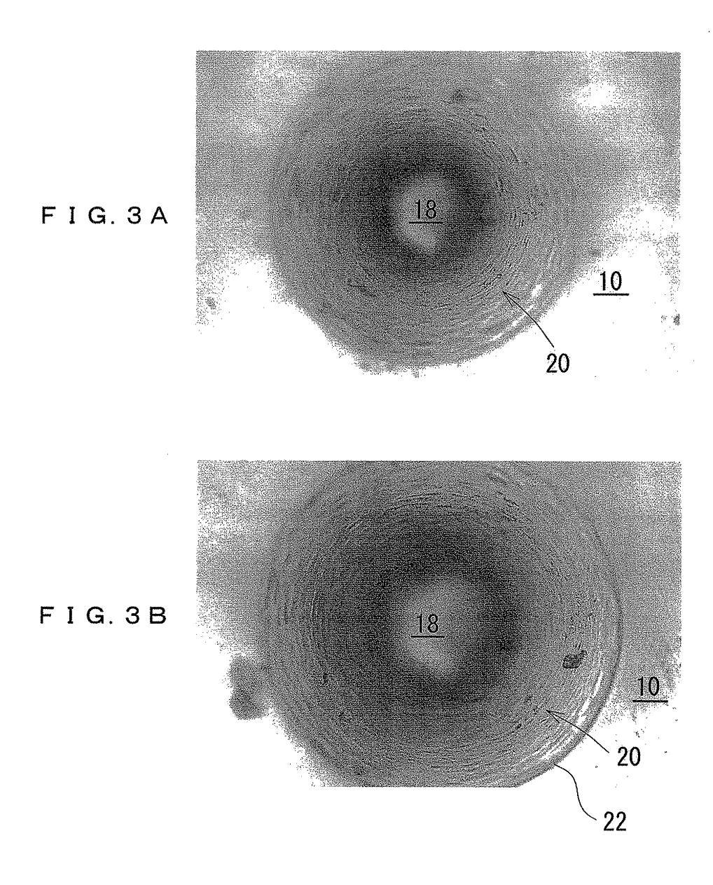

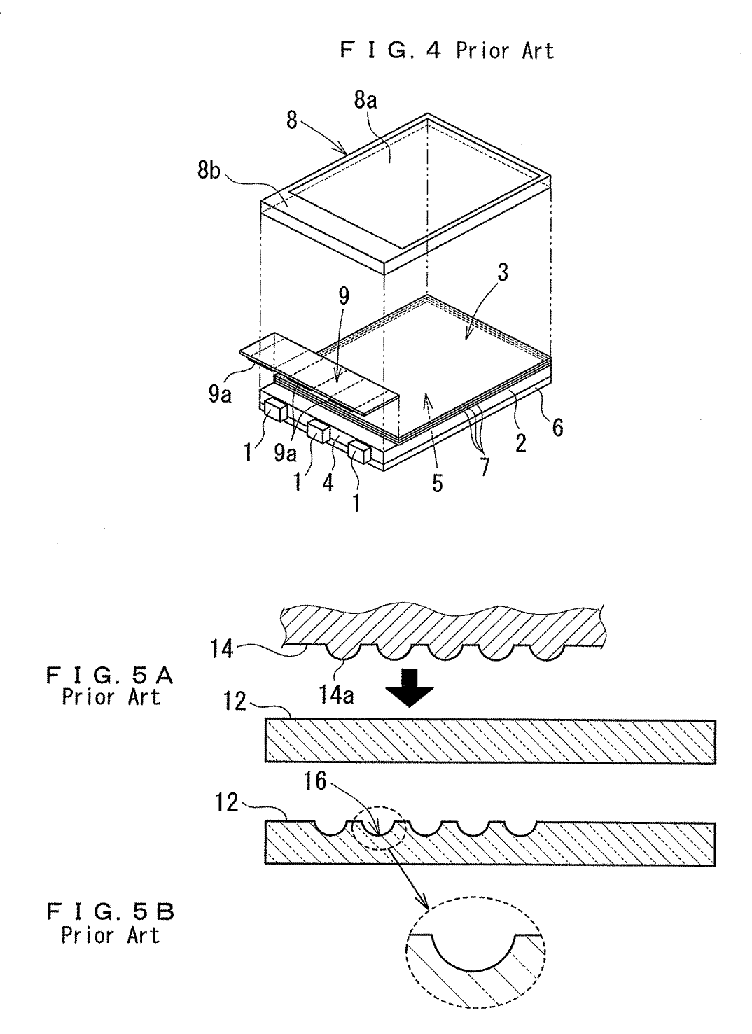

A light conductive plate 10 according to the embodiments of the present invention has, as shown in FIG. 1B and FIG. 3, a plurality of concave dots 18 on the surface of a resin sheet 12, each concave dot 18 being finished by roughening a wall surface 20 thereof. The concave dots 18 are, for example, regularly arranged in longitudinal and horizontal manners in the plane view of the light conductive plate 10. Further, each concave dot 18 is preferably formed with, as shown in FIG. 1B and FIG. 3B, an annular projection 22 that flanges the peripheral end portion of each concave dot 18. Here, the diameter of the peripheral end portion of the concave dot as shown in FIG. 3 is approximately 0.4 mm to 0.5 mm.

In the manufacturing method of the light conductive plate 10, the concave dots 18 are formed on the surface of the resin sheet 12 through a cold press by means of a press die 14 on which a plurality of convex projections 14b are formed. Here, FIG. 1A shows only an upper die for convenience sake; however, a lower die should be properly provided. In case that acrylic is applied as the material of the resin sheet 12, the temperature of the die is set to approximately 130° C., a clamping time is set to approximately 1 second, and a molding cycle time is set to approximately 2 seconds. Here, the melting temperature of acrylic is 80° C. to 90° C., and the temperature of the die becomes more than the melting temperature of acrylic. However, the time where the plurality of convex projections 14b formed on the die deform the resin sheet 12 is set to be a short period as discussed above. Accordingly, a cold-press condition that has no melting in the resin sheet 12 can be established.

The form of the convex projection 14b of the press die 14 is selectable from various options. For example, a square pyramid shape depicted in FIG. 2A, a circular cone shape depicted in FIG. 2B, a wedge shape depicted in FIG. 2C, and a cylindrical shape depicted in FIG. 2D and the like are selectable. Here, the end of the convex projection 14b may be optionally formed with arc as shown in FIG. 2C and FIG. 2D. In any cases, the surface of the convex projection 14b of each press die 14 is smoothly formed.

In the embodiments of the present invention with the above structures, the following operational effects are obtainable. First, considering the light conductive plate 10 according to the embodiments of the present invention, since the concave dots 18 formed on the surface of the resin sheet 12 can deflect light that has introduced from a light source to the interior of the light conductive plate, it would be possible to diffuse light into an extensive range by means of the roughened wall surface 20 of each concave dot 18 contributing to luminous improvement of the light conductive plate 10. Further, since the annular projection 22 that flanges the peripheral end portion of each concave dot 18 substantially increase the depth of the concave dot 18, it would be possible to expand an area contributing to the deflection of the concave dot 18 so as to improve luminance of the light conductive plate 18.

In the manufacturing method of the light conductive plate according to the embodiments of the present invention, with the press stress that pressing the plurality of convex projections 14b of the press die 14 on the surface of the resin sheet 12 through a cold process, material flow with no melting in the resin sheet 12 is caused so as to form the concave dots 18 on the surface of the resin sheet 12. Here, the stress-mark is formed on the wall surface 20 of each concave dot 18 by which the convex projection 14b of the press die 14 is pressed so as to roughen the wall surface of the concave dot 18. This stress-mark will organize constituent of the product of the light conductive plate 12 finished with the roughened wall surface 20 of the concave dots 18.

Further, due to the press stress by which the plurality of convex projections 14b formed on the press die 14 are pressed on the surface of the resin sheet 12 through a cold process, material flow with no melting in the resin sheet 12 is caused so as to form the annular projections 22 flanged at the circumferential end portion of each concave dot 18. This annular projection 22 will organize the constituent of the product of the light conductive plate 12. The height of the annular projection 22 is modifiable according to the penetrated amount of the convex projection relative to the resin sheet 12. The press die 14 by itself thus does not need to have mold for forming the annular projection 22.

Hereinbelow is only for information purpose. When a concave formation is thermal-transferred to an acrylic resin sheet so as to fabricate a light conductive plate, a molding cycle time per 1 shot has been conventionally 60 seconds. In comparison thereto, in the embodiments of the present invention, by applying the cold press, it became possible to shorten the molding cycle time up to approximately 2 seconds as discussed hereinabove. Further, in case of thermal-transferring the concave formation to the acrylic resin sheet for fabricating the light conductive plate, the temperature of a die is conventionally heated up to approximately 170° C. for completely melting the resin sheet. However, in the embodiments of the present invention, since the cold press is applied, as discussed hereinabove, the temperature of the die can be reduced to approximately 130° C. as discussed hereinabove. Any facilities for rapidly cooling down the temperature of the die will be not necessary.

Here, if roughened finish for the wall surface 20 of each concave dot 18 formed on the resin sheet 12 were performed by thermo-transferring the convex projections 14b of the die as conventionally applied, the stress-mark needs to be formed on each convex projection 14b. Accordingly, it can be easily understood that the above method is difficult to be achieved in view of a mold process. Even if achieved, increase of man-hour for die processes is inevitable. On the other hand, as an alternate of the stress-mark, for example, a method where blast treatments are applied on the surface of each convex projection 14b can be named. However, as the same with the above, man-hour for die processes needs to be increased, and since the blast-treated surface formation is thermo-transferred to the resin sheet 12 as the same, there can be found no contribution for cutting a molding cycle time.

1. A light conductive plate comprising:
a resin sheet; and
a plurality of concave dots provided on a surface of the resin sheet, wherein a wall surface of each concave dot is roughened.

2. The light conductive plate according to claim 1, wherein a circumferential end portion of each concave dot has a flanged annular projection.

3. The light conductive plate according to claim 1, wherein each concave dot is formed through a cold press by means of a press die on which a plurality of convex projections are formed.

4. A light conductive plate comprising:
a resin sheet;
a plurality of concave dots provided on a surface of the resin sheet; wherein the plurality of concave dots are formed through a cold press by means of a press die on which a plurality of convex projections are formed.

5. A manufacturing method of a light conductive plate in which to form a plurality of concave dots on a surface of a resin sheet through a cold press by means of a press die on which a plurality of convex projections are formed.

6. The manufacturing method of the light conductive plate according to claim 5, wherein a peripheral end portion of each concave dot has a flanged annular projection.

7. The light conductive plate according to claim 2, wherein each concave dot is formed through a cold press by means of a press die on which a plurality of convex projections are formed.
